(19) United States
(12) Patent Application Publication
(10) Pub. No.: US 2019/0219529 A1
(43) Pub. Date: Jul. 18, 2019

(54) Humidity Measuring Apparatus

(71) Applicant: Hitachi Automotive Systems, Ltd., Hitachinaka-shi, Ibaraki (JP)

(72) Inventors: Masayuki HIO, Hitachinaka-shi (JP); Ryo ANDO, Hitachinaka-shi (JP); Takeo HOSOKAWA, Hitachinaka-shi (JP); Shigenobu KOMATSU, Hitachinaka-shi (JP); Hiroshi ONUKI, Hitachinaka-shi (JP)

(21) Appl. No.: 16/301,537

(22) PCT Filed: Apr. 11, 2017
(86) PCT No.: PCT/JP2017/014769

§ 371 Date: Nov. 14, 2018

(30) Foreign Application Priority Data
May 23, 2016 (JP) 2016-102270

(51) Int. Cl. G01N 25/56

(52) U.S. Cl. CPC G01N 25/56

(57) ABSTRACT

Provided is a humidity measuring apparatus that can measure a humidity of gas with high accuracy even in an environment with pulsation of gas to be measured, in measuring a humidity of gas with a humidity measuring apparatus using a thermal humidity detecting element. The humidity detecting element is disposed in a space offset from an extension line of a pressure introduction passage in a storage chamber, or a space formed on a depth side of a member provided on an extension line of the pressure introduction passage in the storage chamber such that gas introduced from a pressure introduction port into the pressure introduction passage is bent at least once before reaching the humidity detecting element.

### TECHNICAL FIELD

The present invention relates to a humidity measuring apparatus, and for example, relates to a humidity measuring apparatus that is attached to various kinds of device to be measured and measures a humidity of gas flowing in the device.

### BACKGROUND ART

The humidity measuring apparatus is mounted in an intake passage of an internal combustion engine, for example, and is to measure a humidity of intake air passing through the intake passage. A measurement result by the humidity measuring apparatus is used for controlling a fuel injection amount and optimizing an operating condition of the internal combustion engine.

The humidity measuring apparatus for measuring an environment inside the intake passage of the internal combustion engine as described above needs to measure an amount of gas (intake) in real time. For this reason, a high-speed response is desired for such a humidity measuring apparatus, and in order to realize the high-speed response, it is desired to arrange a humidity detecting element (humidity sensor) provided in the humidity measuring apparatus while being exposed in the intake passage. However, when the humidity detecting element is arranged while being exposed in the intake passage, the humidity detecting element may be affected by a turbulent flow due to an intake pulsation caused by a high-speed operation of the internal combustion engine, which may adversely affect the measurement of the gas (intake).

As a conventional technique of such a humidity measuring apparatus, for example, a technique described in PTL 1 has been proposed. In a humidity measuring apparatus described in PTL 1, there is provided a passage communicating from an upstream side to a downstream side of intake air inside the apparatus, and a humidity detecting element to detect a humidity of gas passing through the passage is arranged in a linear part of the passage so as to be exposed.

Meanwhile, as the humidity detecting element used in the humidity measuring apparatus as described above, there is mainly known a capacitance type (e.g. see PTL 1) and a thermal type (e.g., see PTL 2).

A capacitance humidity detecting element (capacitance humidity sensor) detects a change in capacitance due to a change in moisture concentration of a humidity sensitive film, and generally has advantages such as being not easily affected by a pressure and a flow rate, but has, on the other hand, characteristics such as low stain resistance and low responsiveness.

Whereas, a thermal humidity detecting element (thermal humidity sensor) detects a concentration of gas from a heat radiation amount of a heating element provided in the humidity detecting element, and generally has advantages such as high stain resistance and high responsiveness (strong resistance to stain and fast response), but has characteristics such as being easily affected by a pressure and a flow rate. Therefore, when a thermal humidity detecting element is used, a pressure sensor (pressure detecting element) is additionally provided, and a humidity of gas is measured by correcting a concentration of the gas detected by the humidity detecting element, with a pressure of the gas detected by the pressure sensor.

### CITATION LIST

### Patent Literature

PTL 1: JP 2014-010026 A

PTL 2: JP 2016-011889 A

### SUMMARY OF INVENTION

### Technical Problem

In the humidity measuring apparatus described in PTL 1 above, it is possible to accurately measure a humidity of gas (intake air) in an intake passage of an internal combustion engine to some extent by arranging a capacitance humidity detecting element on a linear portion of a passage provided inside the apparatus, even in an environment with intake pulsation caused by a high-speed operation or the like of the internal combustion engine.

However, in measuring a humidity of gas (intake air) passing through an intake passage of an internal combustion engine with a humidity measuring apparatus using a thermal humidity detecting element, when a humidity detecting element is arranged to be exposed on a linear portion of the passage as described in PTL 1, it is strongly affected by turbulence (fluctuation in a flow rate) due to intake pulsation since an air flow near the humidity detecting element is large, making it difficult to measure a humidity with high accuracy, although response is fast.

The present invention has been made in view of the above problems, and it is an object of the present invention to provide a humidity measuring apparatus capable of measuring a humidity of gas with high accuracy even in an environment with intake pulsation caused by a high-speed operation or the like of an internal combustion engine, for example, in measuring a humidity of the gas with a humidity measuring apparatus using a thermal humidity detecting element.

### Solution to Problem

In order to solve the above-mentioned problem, a humidity measuring apparatus according to the present invention includes: a pressure introduction passage consisting of a linear hole having a pressure introduction port configured to take in gas flowing through a main passage; a storage chamber connected to the pressure introduction passage and provided on a side opposite to the main passage side of the pressure introduction passage; and a humidity detecting element configured to detect, from a heat radiation amount of a heating element, a humidity of gas introduced into the pressure introduction passage, and a pressure detecting element configured to detect a pressure of the gas, that are arranged in the storage chamber. The humidity measuring apparatus is to measure a humidity of the gas by correcting a humidity of the gas with a pressure of the gas, and characterized in that the humidity detecting element is disposed in a space offset from an extension line of the pressure introduction passage in the storage chamber, or a space formed on the side opposite to the main passage side of a member provided on an extension line of the pressure introduction passage in the storage chamber, such that the gas introduced into the pressure introduction passage from the pressure introduction port is bent at least once before reaching the humidity detecting element.

### Advantageous Effects of Invention

According to the present invention, it is possible to measure a humidity of gas with high accuracy while suppressing a flow rate even in an environment with pulsation of the gas to be measured.

The problems, configurations, and effects other than those described above will be clarified by the description of the embodiment below.

### BRIEF DESCRIPTION OF DRAWINGS

FIG. 1 is a cross-sectional configuration view illustrating an overall configuration of a first embodiment of a humidity measuring apparatus according to the present invention.

FIG. 2 is an enlarged cross-sectional view of a humidity detecting element illustrated in FIG. 1.

FIG. 3 is an enlarged plan view of the humidity detecting element illustrated in FIG. 1.

FIG. 4 is a cross-sectional configuration view illustrating a vicinity of a humidity detecting element according to a second embodiment of a humidity measuring apparatus according to the present invention, in which FIG. 4(A) is one example, FIG. 4(B) is another example, and FIG. 4(C) is a further example.

FIG. 5 is a cross-sectional configuration view illustrating a vicinity of a humidity detecting element according to a third embodiment of a humidity measuring apparatus according to the present invention, in which FIG. 5(A) is one example, and FIG. 5(B) is another example.

### DESCRIPTION OF EMBODIMENTS

Hereinafter, embodiments of the present invention will be described with reference to the drawings.

### First Embodiment

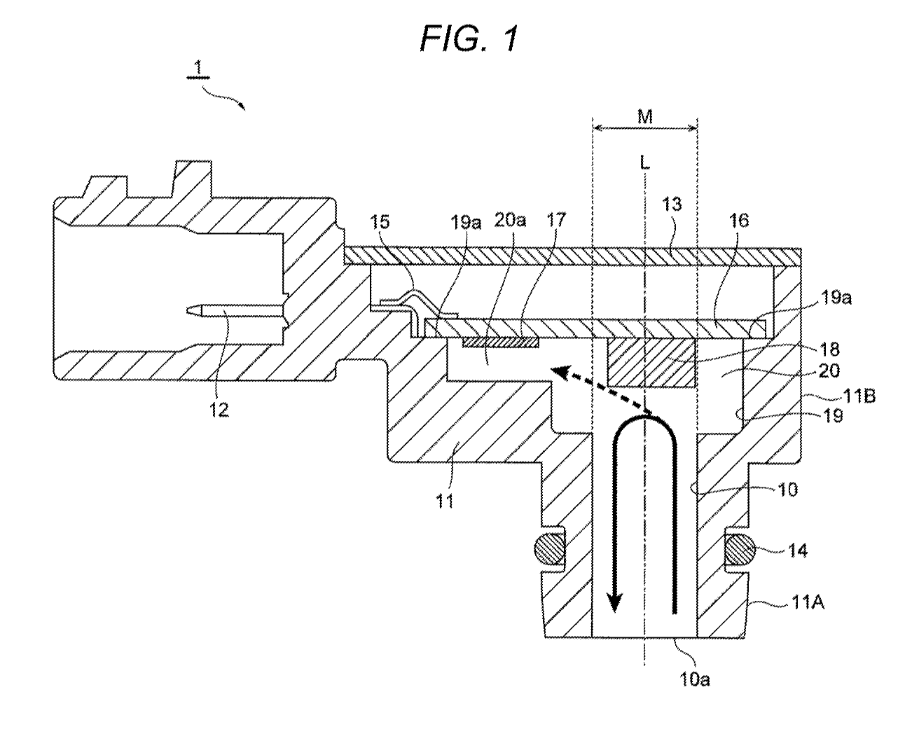

A first embodiment of a humidity measuring apparatus according to the present invention will be described with reference to FIGS. 1 to 3.

FIG. 1 is a cross-sectional configuration view illustrating the first embodiment of the humidity measuring apparatus according to the present invention.

A humidity measuring apparatus 1 of the illustrated embodiment is attached to an intake passage of an internal combustion engine, for example, to measure a humidity of air (intake air) passing through the intake passage, and mainly includes a casing 11 made of resin, a circuit board 16, and a cover 13.

The casing 11 has a hollow cylindrical fitting part 11A to be fitted into a device to be measured (e.g., an intake passage), and a main body 11B equipped with the circuit board 16 and the like. In order to take in gas flowing through a main passage of the device to be measured, the fitting part 11A is provided with a pressure introduction passage 10 consisting of a linear hole having a pressure introduction port 10a that opens to one end side (a lower side, the main passage side on which the gas to be measured flows) in an axis L direction. Further, the main body 11B is provided with a storage hole 19 that is wider than the pressure introduction passage 10 and is consisting of a concave hole having an opening at an upper end (an end opposite to the main passage side), such that the storage hole 19 connects to another end side in the axis L direction of the pressure introduction passage 10 (an upper side, the side opposite to the main passage side). The storage hole 19 is formed with a step so as to spread stepwise as approaching the upper side (the side opposite to the main passage side). To a stepped portion (surface) 19a formed on an inner wall (inner peripheral wall) of the storage hole 19, the circuit board 16 consisting of a flat plate member is fixed by adhesion or the like, and the flat-plate shaped cover 13 is attached so as to close an upper end opening of the storage hole 19 (that is, an upper end opening of the main body 11A of the casing 11). The circuit board 16 is arranged in the storage hole 19 such that (a lower surface (mounting surface) of) the circuit board 16 is perpendicular to the axis L of the pressure introduction passage 10. This circuit board 16 divides the storage hole 19 into a lower region exposed to gas (intake) to be measured and an upper region not exposed to the gas, and the lower region is a storage chamber 20 arranged with a humidity detecting element 17 and a pressure detecting element 18 to be described later.

Further, in the main body 11B of the casing 11, a connector 12 to electrically connect to outside is integrally provided, and the circuit board 16 and the connector 12 are electrically connected by a metal wire 15 provided in the upper region of the storage hole 19.

Further, to an outer periphery of the fitting part 11A of the casing 11 (specifically, in an annular groove provided on the outer periphery of the fitting part 11A), an O-ring 14 to ensure airtightness is attached.

On a lower surface of the circuit board 16 (mounting surface on the storage chamber 20 side), there are mounted side by side the humidity detecting element (humidity sensor) 17 configured to measure a humidity of gas (intake) having introduced into the pressure introduction passage 10 via the pressure introduction port 10a and passed through the pressure introduction passage 10, and the pressure detecting element (pressure sensor) 18 configured to measure a pressure of the gas. The circuit board 16, the humidity detecting element 17, and the pressure detecting element 18 are electrically connected to each other.

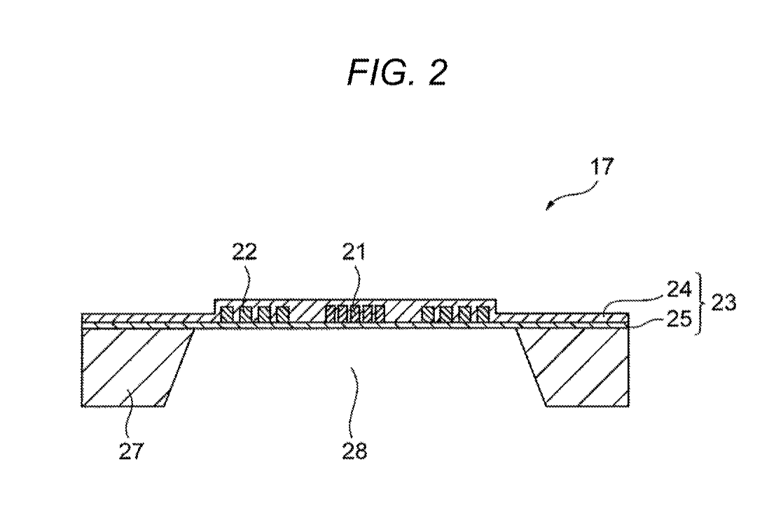

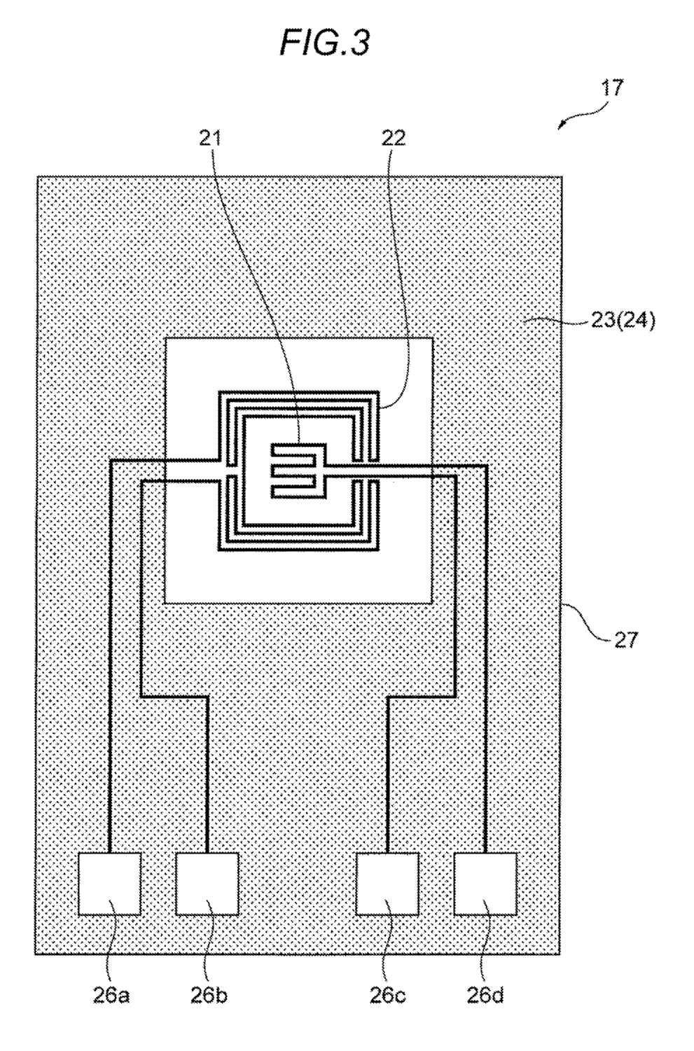

FIGS. 2 and 3 are an enlarged cross-sectional view and an enlarged plan view illustrating the humidity detecting element 17 illustrated in FIG. 1.

The humidity detecting element 17 has a silicon substrate 27 formed of single crystal silicon. The silicon substrate 27 is formed with a cavity 28, and on the cavity 28, a main heater 21 as a first heating element and a sub heater 22 as a second heating element are laid. Further, in order to support these heating elements (the main heater 21 and the sub heater 22), a thin film support 23 is formed so as to be located on the cavity portion 28 of the silicon substrate 27.

Here, the thin film support 23 is formed of insulation layers 24 and 25 laminated on an upper surface of the silicon substrate 27, and the main heater 21 and the sub heater 22 are interposed and supported between the insulation layers 24 and 25. The sub heater 22 is arranged so as to surround a periphery of the main heater 21.

The main heater 21 dissipates heat by heat transfer to air flowing around. Since a thermal conductivity of air varies depending on a humidity to cause a change of a heat radiation amount, measuring a voltage value or a current value based on the heat radiation amount of the main heater 21 can provide a signal corresponding to the humidity to be obtained. Arranging the sub heater 22 around the main heater 21 provides a function to maintain an ambient temperature of the main heater 21 at a temperature of the sub heater 22, which enables compensation for a dependence of the ambient temperature.

The main heater 21 and the sub heater 22 each extend along a plane of the thin film support 23 (a surface of the insulation layer 25), are consisting of a fine width resistor having a plurality of folded portions, and are provided with electrodes 26a, 26b, 26c, and 26d for connection with a drive circuit (not shown).

As a material for forming the main heater 21 and the sub heater 22, a material stable at high temperature (material having a high melting point), for example, platinum (Pt), tantalum (Ta), molybdenum (Mo), silicon (Si), or the like is selected. As a material for forming the insulation layers 24 and 25, for example, silicon oxide (SiO₂) and silicon nitride (Si₃N₄) are selected in a single layer or a laminated configuration. In addition, as a material for forming the insulation layers 24 and 25, a resin material such as a polyimide, ceramic, glass, or the like can also be selected in a single layer or a laminated configuration. Further, as a material for forming the electrodes 26a, 26b, 26c, and 26d, for example, aluminum (Al), gold (Au), or the like is selected.

This humidity detecting element 17 is formed by using, for example, a semiconductor microfabrication technique using photolithography, or an anisotropic etching technique. Further, the cavity 28 can be formed by anisotropic etching of the silicon substrate 27.

Whereas, the upper surface of the circuit board 16 is mounted with, although not shown, an amplifier configured to amplify each detection signal output from the humidity detecting element 17, an A/D converter configured to convert an analog output signal of the amplifier into a digital signal, a digital signal arithmetic processing circuit configured to perform correction calculation based on the digital signal, an integrated circuit mounted with a memory or the like storing various kinds of data, a capacitor, and the like. As described above, the humidity detecting element 17 outputs a heat radiation amount of the main heater 21 as an electric signal. Accordingly, when a pressure around the humidity detecting element 17 changes, the output of the humidity detecting element 17 also changes. Therefore, in the integrated circuit, the humidity is corrected with a pressure by using the output of the pressure detecting element 18. Specifically, a humidity of gas is measured by correcting a gas concentration (humidity) detected from the heat radiation amount of the main heater 21 by the humidity detecting element 17, with a pressure of the gas detected by the pressure detecting element 18. It should be noted that, by making the circuit board 16 a multi-layer substrate, these components can also be mounted on both sides of such a substrate.

Here, in the present embodiment, as can be understood well with reference to FIG. 1, the humidity detecting element 17 configured to detect a humidity of gas is mounted on the lower surface (mounting surface) of the circuit board 16 so as to be located at a position distant from the axis L of the pressure introduction passage 10, more specifically, so as to be located in a space 20a offset from an extension line (M region in the figure) of the pressure introduction passage 10 in the storage chamber 20 that is formed on a depth side (the side opposite to the main passage side) of the pressure introduction passage 10. More specifically, the humidity detecting element 17 is mounted on the lower surface of the circuit board 16 so as to be disposed in the space 20a having a relatively small volume provided contiguously to a lower side of the stepped portion 19a provided to (the main body 11B of) the casing 11. That is, the humidity detecting element 17 is disposed at a position (space 20a) that is invisible when viewed from the pressure introduction passage 10 side (in the axis L direction) of the casing 11.

In addition, here, the pressure detecting element 18 configured to measure a pressure of gas is mounted on the lower surface (mounting surface) of the circuit board 16 so as to be located on the axis L of the pressure introduction passage 10. That is, the pressure detecting element 18 is disposed at a position that is visible when viewed from the pressure introduction passage 10 side (in the axis L direction) of the casing 11.

Although the mounting position of the pressure detecting element 18 is not limited to the illustrated example, it is preferable to arrange the pressure detecting element 18 near the humidity detecting element 17 in order to secure the measurement accuracy.

That is, in the present embodiment, the humidity detecting element 17 is arranged in the space 20a on a depth side of the storage chamber 20, and a gas passage from the pressure introduction port 10a in the casing 11 to the humidity detecting element 17 is bent at least once, in other words, the gas introduced from the pressure introduction port 10a into the pressure introduction passage 10 is bent at least once (in this example, it is bent in an approximately 90° L shape) before reaching the humidity detecting element 17 (a flow of the dotted line in FIG. 1).

In the humidity measuring apparatus 1 having such a configuration, gas (intake air) introduced from the pressure introduction port 10a advances straight in the pressure introduction passage 10 (toward the axis L direction), and collides with the circuit board 16 arranged in the housing chamber 20 on a depth side of the pressure introduction passage 10, to generate a turbulent flow (a flow of the solid line in FIG. 1). Particularly, in an environment with pulsation, the influence of the turbulence is increased. In the humidity measuring apparatus 1 of the present embodiment, by bending the gas passage above, in other words, bending the gas having passed through the pressure introduction passage 10 before reaching the humidity detecting element 17, a turbulent flow having advanced straight through the pressure introduction passage 10 from the pressure introduction port 10a does not easily reach the humidity detecting element 17. This enables measurement of a humidity of gas (intake) with high accuracy while suppressing a flow rate (fluctuation), even in an environment with pulsation of the gas.

### Second Embodiment

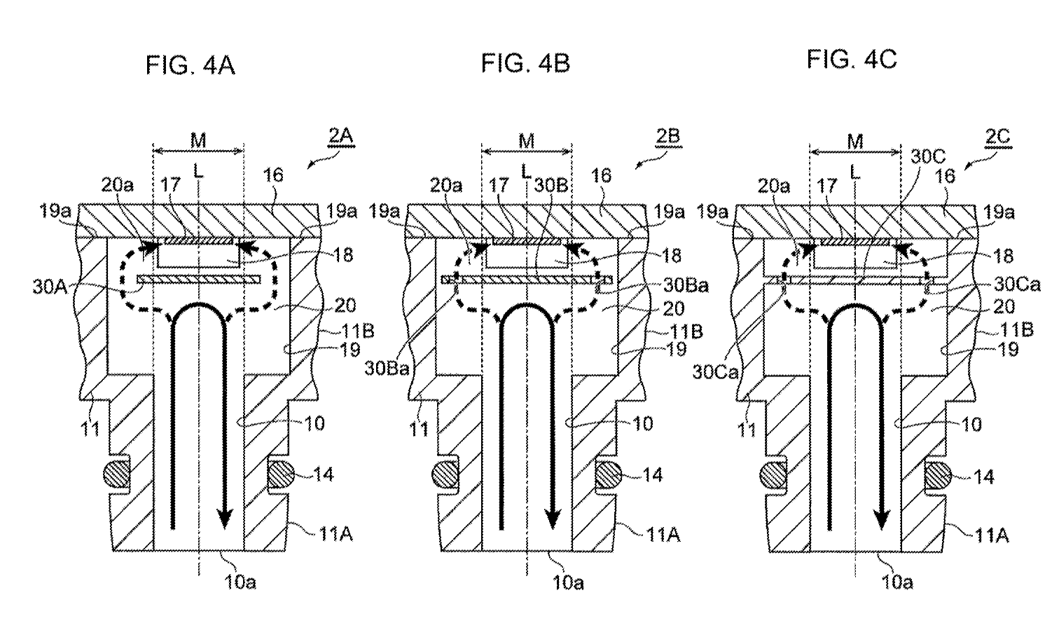

Next, a second embodiment of a humidity measuring apparatus according to the present invention will be described with reference to FIG. 4.

FIGS. 4(A) to 4(C) each are cross-sectional configuration views illustrating around a humidity detecting element of the second embodiment of the humidity measuring apparatus according to the present invention. It should be noted that similar reference numerals are given to configurations having similar action functions as those of the first embodiment above, and a detailed description thereof will be omitted.

In a humidity measuring apparatus 2A according to the second embodiment shown in FIG. 4(A), on an axis L of a pressure introduction passage 10 in a storage chamber 20 provided in a casing 11, a partition member 30A consisting of a flat plate member wider than the pressure introduction passage 10 and narrower than the storage chamber 20 is erected (so as to be substantially perpendicular to the axis L of the pressure introduction passage 10). Further, so as to face a back surface (a surface on a side opposite to a main passage side) of the partition member 30A, a humidity detecting element 17 is mounted on a lower surface of a circuit board 16. More specifically, the humidity detecting element 17 is mounted on the lower surface of the circuit board 16 so as to be disposed in a space 20a having a relatively small volume provided on a depth side of the partition member 30A. Similarly to the first embodiment above, the humidity detecting element 17 is disposed at a position (space 20a) that is invisible when viewed from the pressure introduction passage 10 side (in the axis L direction) of the casing 11.

Further, here, a pressure detecting element 18 is mounted on the lower surface (mounting surface) of the circuit board 16 so as to be located on a depth side of the humidity detecting element 17 in the drawing. That is, similar to the humidity detecting element 17, the pressure detecting element 18 is mounted on the lower surface of the circuit board 16 so as to be disposed in the space 20a having a relatively small volume provided on the depth side of the partition member 30A, and is arranged at a position (space 20a) that is invisible when viewed from the pressure introduction passage 10 side (in the axis L direction) of the casing 11.

That is, in the present embodiment, the partition member 30A that is wider than the pressure introduction passage 10 is provided between a pressure introduction port 10a and the humidity detecting element 17 arranged so as to be located on the axis L of the pressure introduction passage 10, and gas (intake air) introduced into the pressure introduction passage 10 from the pressure introduction port 10a reaches the humidity detecting element 17 arranged at the rear of the partition member 30A via a space formed on a side of the partition member 30A in the storage chamber 20 (a space formed between a side portion of the partition member 30A and an inner wall of the storage chamber 20), which is a space at a position off (offset) from an extension line of the pressure introduction passage 10 (M region in the drawing). That is, also in the humidity measuring apparatus 2A of the present embodiment, a gas passage from the pressure introduction port 10a in the casing 11 to the humidity detecting element is bent at least once, in other words, the gas introduced from the pressure introduction port 10a into the pressure introduction passage 10 is bent at least once before reaching the humidity detecting element 17 (in this example, it is bent three times each at approximately 90°) (a flow of the dotted line in FIG. 4 (A)).

In the humidity measuring apparatus 2A having such a configuration, gas (intake air) introduced from the pressure introduction port 10a advances straight in the pressure introduction passage 10 (toward the axis L direction), collides with the partition member 30A arranged in the housing chamber 20 on a depth side of the pressure introduction passage 10, and generates a turbulent flow toward the pressure introduction port 10a (a flow of the solid line in FIG. 4 (A)). In the humidity measuring apparatus 2A of the present embodiment, since the humidity detecting element 17 is on the circuit board 16 on the depth side of the partition member 30A that is wider than the pressure introduction passage 10, and the above-described gas passage is bent, in other words, the gas having passed through the pressure introduction passage 10 is bent before reaching the humidity detecting element 17, a turbulent flow does not easily reach the humidity detecting element 17. This enables measurement of a humidity of gas (intake) with high accuracy while suppressing a flow rate (fluctuation), even in an environment with pulsation of the gas.

It should be noted that, in the above embodiment, the side portion of the partition member 30A and the inner wall of the storage chamber 20 are not in contact with each other, and gas introduced into the pressure introduction passage 10 reaches the humidity detecting element 17 via the space formed on the side of the partition member 30A in the storage chamber 20. However, as shown in FIGS. 4(B) and 4(C), one or more through holes 30Ba and 30Ca may be formed at positions off from the extension line of the pressure introduction passage 10 in partition members 30B and 30C of humidity measuring apparatuses 2B and 2C (a side portion of the partition member 30B is not in contact with the inner wall of the storage chamber 20 in FIG. 4(B), and a side portion of the partition member 30C is in contact with the inner wall of the storage chamber 20 in FIG. 4(C)), and gas introduced into the pressure introduction passage may reach the humidity detecting element 17 via the through holes 30Ba and 30Ca.

It is needless to say that the number, a shape (hole diameter and the like), a position, and the like of the through holes 30Ba and 30Ca of the partition members 30B and 30C shown in FIGS. 4(B) and 4(C) can be appropriately changed.

In addition, the partition members 30A, 30B, and 30C shown in FIGS. 4(A) to 4(C) may be formed separately (as separate parts) from the casing 11, or may be integrally formed with the casing 11.

### Third Embodiment

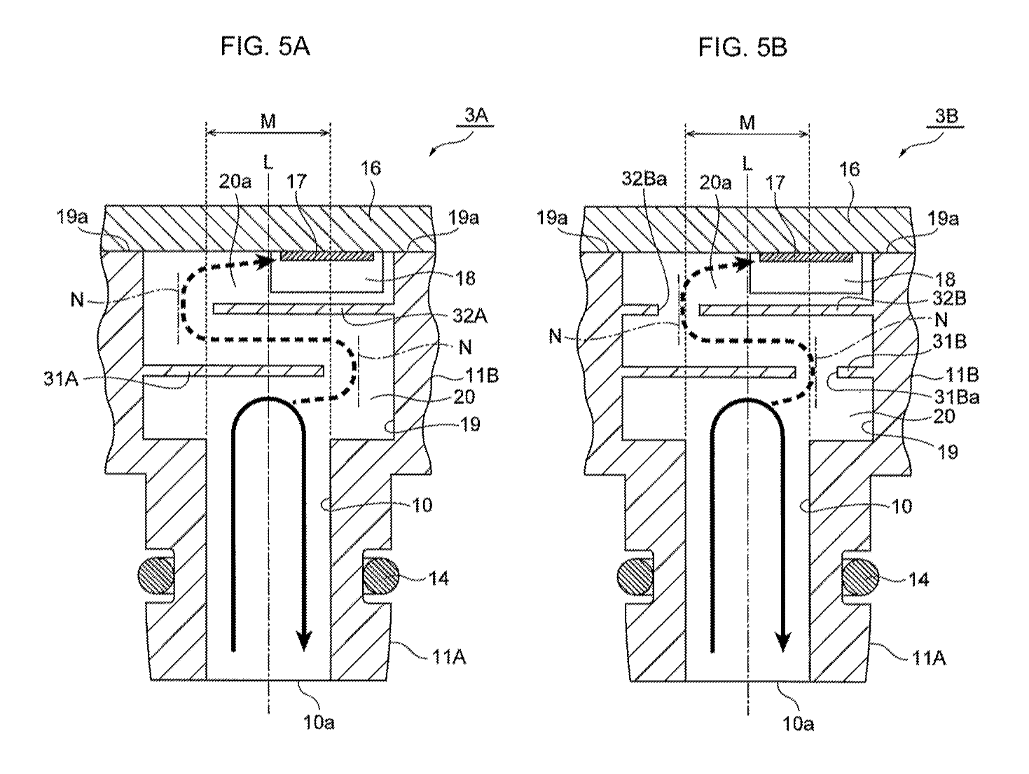

Next, a third embodiment of a humidity measuring apparatus according to the present invention will be described with reference to FIG. 5.

FIGS. 5(A) and 5(B) each are cross-sectional configuration views illustrating around a humidity detecting element of the third embodiment of the humidity measuring apparatus according to the present invention. It should be noted that similar reference numerals are given to configurations having similar action functions as those of the first embodiment above, and a detailed description thereof will be omitted.

In a humidity measuring apparatus 3A according to the third embodiment shown in FIG. 5(A), on an axis L of a pressure introduction passage 10 in a storage chamber 20 provided in a casing 11, a plurality of (two in the illustrated example) partition members 31A and 32A similar to those in the second embodiment above are erected separately in the axis L direction of the pressure introduction passage 10. Further, so as to face a back surface (a surface on a side opposite to a main passage side) of the partition member 32A on a depth side of the partition members 31A and 32A (the side opposite to the main passage side), a humidity detecting element 17 is mounted on a lower surface of a circuit board 16. More specifically, the humidity detecting element 17 is mounted on the lower surface of the circuit board 16 so as to be disposed in a space 20a having a relatively small volume provided on a depth side of the partition member 32A. Similarly to the first embodiment above, the humidity detecting element 17 is disposed at a position (space 20a) that is invisible when viewed from the pressure introduction passage 10 side (in the axis L direction) of the casing 11.

Here, while one side portion of each of the partition members 31A and 32A is in contact with an inner wall of the storage chamber 20, only side portions on respectively different sides are in contact with the inner wall of the storage chamber 20. Further, a space formed on a side of the partition member 31A in the storage chamber 20 (a space formed between the side portion of the partition member 31A and the inner wall of the storage chamber 20) is not lapped (not overlapped) with a space formed on a side of the partition member 32A (a space formed between the side portion of the partition member 32A and the inner wall of the storage chamber 20) when viewed in the axis L direction of the pressure introduction passage 10. That is, a gas passage axis (an axis representing a flow direction when gas flows through the space) N defined by the spaces formed between the inner wall of the storage chamber 20 and the side portions of the partition members 31A and 32A is set at different positions.

Further, here, a pressure detecting element 18 is mounted on the lower surface (mounting surface) of the circuit board 16 so as to be located on a depth side of the humidity detecting element 17 in the drawing. That is, similar to the humidity detecting element 17, the pressure detecting element 18 is mounted on the lower surface of the circuit board 16 so as to be disposed in the space 20a having a relatively small volume provided on the depth side of the partition member 32A, and is arranged at a position (space 20a) that is invisible when viewed from the pressure introduction passage 10 side (in the axis L direction) of the casing 11.

That is, in the present embodiment, between the pressure introduction port 10a and the humidity detecting element 17 arranged so as to be located on an extension line (M region in the figure) of the pressure introduction passage 10, the plurality of partition members 31A and 32A similar to those in the second embodiment above are provided (separately in the axis L direction of the pressure introduction passage 10). Further, gas (intake air) introduced into the pressure introduction passage 10 from the pressure introduction port 10a reaches the humidity detecting element 17 arranged at the rear of the partition member 32A via a space formed on a side of the partition member 31A on a front side in the storage chamber (a space formed between the side portion of the partition member 31A and the inner wall of the storage chamber 20), a space between the partition member 31A and the partition member 32A, and a space formed on a side of the partition member 32A on a depth side (a space formed between the side portion of the partition member 32A and the inner wall of the storage chamber 20). That is, also in the humidity measuring apparatus 3A of the present embodiment, the gas passage from the pressure introduction port 10a in the casing 11 to the humidity detecting element is bent at least once, in other words, the gas introduced from the pressure introduction port 10a into the pressure introduction passage 10 is bent at least once before reaching the humidity detecting element 17 (in this example, it is bent five times each at approximately 90°) (a flow of the dotted line in FIG. 5 (A)).

In the humidity measuring apparatus 3A of the present embodiment, since the gas passage axis of the two adjacent partition members 31A and 32A is set at different positions as described above, it is possible to further reduce the influence of the turbulent flow generated by a collision of the gas (intake) introduced from the pressure introduction port 10a with the partition member 31A. This enables measurement of a humidity of gas (intake) with high accuracy while suppressing a flow rate (fluctuation), even in an environment with pulsation the gas.

It should be noted that, in the above embodiment, one side portion of each of the partition members 31A and 32A is not in contact with the inner wall of the storage chamber 20, and gas introduced into the pressure introduction passage 10 reaches the humidity detecting element 17 via the space formed on a side of each of the partition members 31A and 32A in the storage chamber 20. However, as shown in FIG. 5 (B), it is possible to form one or more through holes 31Ba and 32Ba respectively (in the example shown in FIG. 5(B), each one of the through holes 31Ba and 32Ba is formed in each of the partition members 31B and 32B) in the partition members 31B and 32B (here, both side portions of the partition members 31B and 32B are in contact with the inner wall of the storage chamber 20) of a humidity measuring apparatus 3B, set the through holes 31Ba and 32Ba provided in adjacent partition members 31B and 32B not to be lapped (not overlapped) when viewed in the axis L direction of the pressure introduction passage (that is, the gas passage axis (the axis representing a flow direction when gas flows through the through hole) N defined by the through holes 31Ba and 32Ba of the respective partition members 31B and 32B is set at different positions), and allow gas introduced into the pressure introduction passage 10 to reach the humidity detecting element 17 meandering through the through holes 31Ba and 32Ba of the respective partition members 31B and 32B.

Further, while two partition members are employed in the above embodiment, it is needless to say that three or more of such partition members may be provided.

Further, the partition members 31A, 32A, 31B, and 32B shown in FIGS. 5(A) and 5(B) may be formed separately (as separate parts) from the casing 11, or may be integrally formed with the casing 11.

Note that the present invention is not limited to the above embodiments, and various modifications may be included. For example, the embodiments described above have been illustrated in detail to facilitate description for easy understanding, and are not necessarily limited to the embodiments that include all the configurations. Additionally, a part of a configuration of an embodiment may be replaced with a configuration of another embodiment, and a configuration of an embodiment may be added with a configuration of another embodiment. Moreover, a part of a configuration of each embodiment may be deleted, replaced, or added with another configuration.

### REFERENCE SIGNS LIST

1 humidity measuring apparatus
10 pressure introduction passage
10a pressure introduction port
11 casing
12 connector
13 cover
14 O-ring
15 metal wire
16 circuit board
17 humidity detecting element (humidity sensor)
18 pressure detecting element (pressure sensor)
19 storage hole
20 storage chamber
21 main heater
22 sub heater
23 thin film support
24 insulation layer
25 insulation layer
26a to 26d electrode
27 silicon substrate
28 cavity
30A, 30B, 30C, 31A, 31B, 32A, 32B partition member
30Ba, 30Ca, 31Ba, 32Ba through hole
L axis
N gas passage axis

1. A humidity measuring apparatus comprising: a pressure introduction passage consisting of a linear hole having a pressure introduction port configured to take in gas flowing through a main passage; a storage chamber connected to the pressure introduction passage and provided on a side opposite to the main passage side of the pressure introduction passage; and a humidity detecting element configured to detect, from a heat radiation amount of a heating element, a humidity of gas introduced into the pressure introduction passage, and a pressure detecting element configured to detect a pressure of the gas, that are arranged in the storage chamber, the humidity measuring apparatus measuring a humidity of the gas by correcting a humidity of the gas with a pressure of the gas,
wherein gas introduced from the pressure introduction port into the pressure introduction passage is bent at least once before reaching the humidity detecting element by disposing the humidity detecting element in a space offset from an extension line of the pressure introduction passage in the storage chamber, or a space formed on a side opposite to the main passage side of a member provided on an extension line of the pressure introduction passage in the storage chamber.

2. The humidity measuring apparatus according to claim 1, wherein the humidity detecting element and the pressure detecting element are mounted on a mounting surface of a circuit board, and the circuit board is arranged in the storage chamber with the mounting surface being perpendicular to an axis of the pressure introduction passage.

3. The humidity measuring apparatus according to claim 1, wherein
the member is formed to be wider than the pressure introduction passage; and
gas introduced into the pressure introduction passage reaches the humidity detecting element via a space formed between a side portion of the member and an inner wall of the storage chamber.

4. The humidity measuring apparatus according to claim 1, wherein
the member is formed to be wider than the pressure introduction passage; and
gas introduced into the pressure introduction passage reaches the humidity detecting element via one or more through holes provided at a position off from an extension line of the pressure introduction passage in the member.

5. The humidity measuring apparatus according to claim 1, wherein the member includes a plurality of members provided separately in an axial direction of the pressure introduction passage, a space through which gas flows is provided between each of the plurality of members and an inner wall of the storage chamber, and the spaces on a side of adjacent members do not overlap with each other when viewed in an axial direction of the pressure introduction passage; and
gas introduced into the pressure introduction passage reaches the humidity detecting element via each space on a side of the plurality of members.

6. The humidity measuring apparatus according to claim 1, wherein the member includes a plurality of members provided separately in an axial direction of the pressure introduction passage, each of the plurality of members is provided with a through hole; through holes provided in adjacent members do not overlap with each other when viewed in an axial direction of the pressure introduction passage; and gas introduced into the pressure introduction passage reaches the humidity detecting element via each through hole in the plurality of members.
